(19) United States
(12) Patent Application Publication
(10) Pub. No.: US 2007/0034343 A1
(43) Pub. Date: Feb. 15, 2007

(54) Window screen

(76) Inventor: Joseph G. Zahka, Andover, MA (US)

Correspondence Address: MCCORMICK, PAULDING & HUBER LLP, CITY PLACE II, 185 ASYLUM STREET, HARTFORD, CT, 06103, US

(21) Appl. No.: 11/479,585

(22) Filed: Jun. 30, 2006

Related U.S. Application Data
(60) Provisional application No. 60/708,214, filed on Aug. 15, 2005.

(51) Int. Cl. E06B 9/24

(52) U.S. Cl. 160/371

(57) ABSTRACT

A window screen for use adjacent a window of a structure for blocking a substantial portion of direct sunlight from entering the structure through the window while providing a generally unobstructed field of view through the window screen. The window screen includes a web having a generally uniform thickness and defining a plurality of openings therethrough, each opening having a depth dimension defined by and substantially equal to the thickness of the web and an opening dimension being generally transverse to the depth dimension. The depth dimension is greater than or equal to the opening dimension such that light rays entering the openings generally in the plane of the maximum opening dimension at an angle measured from a plane defined by a surface of the web are blocked from directly passing through the openings due to the light rays contacting the web along the depth of the openings.

### CROSS-REFERENCE TO RELATED APPLICATION

This application claims the benefit of U.S. Provisional Application No. 60/708,214, filed Aug. 15, 2005, which is incorporated herein by reference.

### FIELD OF THE INVENTION

The present invention generally relates to a screen for use with an opening of a structure, and more particularly, to a window screen for blocking a substantial portion of direct sunlight from entering a structure through a window while minimizing obstructions to the field of view through the window screen.

### BACKGROUND OF THE INVENTION

As used herein, the term “structure” generally encompasses and refers to houses, buildings, vehicles, campers, boats and other structures normally having windows or openings for permitting light to enter an interior area of the structure; for providing a field of view into or out of the structure; for ventilation of the interior area of the structure; and/or for preventing environmental nuisances, such as insects, from getting into the interior area of the structure. In general, the incidence of sunlight on and through windows of a structure causes the air temperature inside of the structure to increase, which can cause discomfort to occupants of the structure. Additionally, direct sunlight and the associated increase in temperature can damage items inside of the structure—e.g., increased direct sunlight may cause fading and cracking of surfaces and objects within the structure, such as furniture and carpeting. Thus, often, it is very desirable to block or impede direct sunlight from entering a structure through the windows of the structure.

Traditionally, sunlight could be blocked from entering a window by closing shutters on the outside of the window or drawing drapes inside the room. Consequently, these devices often block too much light and make the room too dark. Moreover, these devices obstruct the field of view outside the window—in order to see something outside, one would need to open the shutters or drapes, which would let the sunlight into the room. Shutters and drapes, when closed, also affect ventilation of the room.

Sunscreens and other devices have been developed for use in blocking sunlight from entering a structure through windows while not drastically obstructing the field of view through the window. Mini-blinds, for example, include numerous narrow horizontal slats suspended one above the other and mounted inside a window in a home or office. The slats are commonly about one inch deep, spaced about one inch apart, and arranged so that the angle of the slats to the window surface can be adjusted to block the sun entering the window, but still permit some level of visibility out the window. Thus, as the position of the sun in the sky, and consequently the angle of direct rays of sunlight entering a window, changes, the blinds can be adjusted to block the light rays. However, many angles at which the slats of the blinds may be positioned, while adequate for blocking direct sunlight from getting into the room, can still greatly obstruct visibility out of the window. For example, when the slats are adjusted to a near vertical position, the blinds are essentially acting much in the manner of the traditional shutter or drape designs discussed above. To increase visibility from within the room, the slats can be positioned horizontally. Alternatively, the slats can be drawn together and raised to a storage position. However, in these positions, the slats cannot block light from entering the room through the window. Moreover, mini-blinds are typically mounted on the inside of a window, within the structure. The heat from the sunlight, though blocked by slats positioned at an appropriate angle, has already entered the room, and the blinds merely act to redirect the heat within the room. Accordingly, mini-blinds are normally not very effective in keeping a structure cool. Further, mini-blinds of the type described above typically have gaps between adjacent slats, and therefore provide no structure to prevent insects from entering the structure through the window, if opened.

Awnings may also be used to block direct sunlight from entering through a window. Such awnings are typically mounted outside the window and protrude outwardly away from the house. Such awnings may be retractable, and therefore adjusted based on the position of the sun in the sky. Awnings that extend several feet away from the house provide greater protection from rays of sunlight at varying angles; however, such awnings, while adequately blocking sunlight, can act to obstruct the field of view out of the window and can also be an eyesore. Moreover, such awnings provide no assistance for ventilation of the structure, and in order to provide adequate airflow, the window must be opened, allowing for little prevention against insects entering the structure through the open window.

Various types of window coatings are also available and used to provide some protection from the sun entering a structure through the windows thereof. Typically, coated windows are tinted in varying degrees with a plastic or metal coating in various shades to block sunlight from passing through the window, similar to sunglasses. In general, the darker the shading, the more sunlight that will be blocked from passing through the window. Most window coatings, however, provide a permanent coating and therefore also reduce the visibility through the window. The reduced visibility through a shaded window can be especially noticeable at night and on cloudy days. Further, a shaded window may be detrimental during the winter, when it may be desirable to permit sunlight to enter a window to heat the interior area of the structure.

In some cases, the degree of shading on a coated window may be variable. For example, in certain window products, the shading on the window can be made darker by applying an electric charge across the window. However, these types of windows can be expensive and require additional circuitry and controls. Alternatively, window glass that darkens automatically when exposed to sunlight, similar to Photogray® eyeglass lenses, may also be available for some applications. However, these too are relatively expensive when compared to traditional type windows having clear glass or alternative window screen designs

Whether or not the coating is permanent, coated windows, such as those described above, do not provide all of the features of a typical window screen, such as allowing airflow through the window and therefore ventilation of the interior of a structure. Accordingly, in order to allow air to flow through a coated window, the window is normally opened which eliminates much of the sunscreen benefits of the shaded glass. Further, an additional screen may also be required to prevent insects from entering a structure having windows with shaded glass where the window is opened to improve ventilation.

Sunblocking screens including a fiberglass mesh filled with various types of plastic material are also currently available in the marketplace from manufacturers such as Phifer and as disclosed in, for example, U.S. Pat. Nos. 4,002,188 and 4,587,997. To block light rays, most such screens utilize openings with reduced size and increase the dimension of the fiberglass mesh defining such openings. As a result, airflow and visibility through the screen are diminished. For example, a 70% sunblocking screen may be approximately 70% filled with plastic, leaving only 30% of the total area of the screen open to allow air to pass through.

An additional alternative for countering the effects of direct sunlight entering a room is to use an air conditioner for cooling the air inside the room. Often, however, operating air conditioners can be expensive, especially for a large structure. Further, air conditioners will not help to prevent damage such as fading caused to the interior of the structure or the contents thereof due to the incidence of direct sunlight. Moreover, window-mounted air conditioning units, while regulating the temperature of an interior area, greatly obstruct the field of view out of the window.

Based on the foregoing, it is the general object of the present invention to provide a window screen that improves upon, or overcomes the problems and drawbacks associated with prior art window screens.

### SUMMARY OF THE INVENTION

The present invention provides a screen for use on a window of a structure for blocking a portion of direct sunlight from entering the structure through the window while providing a substantially uninhibited field of view through the screen. The screen preferably includes a web having a generally uniform thickness and defining a plurality of openings therethrough, each of the openings having a maximum depth dimension defined by and substantially equal to the thickness of the web and a maximum opening dimension being generally transverse to the maximum depth dimension. The maximum depth dimension is preferably greater than or equal to the maximum opening dimension such that light rays entering the openings generally in the plane of the maximum opening dimension at an angle measured from a plane defined by a surface of the web is blocked from directly passing through the openings due to the light rays contacting the web along the depth of the openings. The openings block light rays at an angle from the web plane up to a maximum angle in the range of about 45 degrees to about 85 degrees measured from the web plane. A field of view through the openings generally perpendicular to said plane is generally uninhibited by the web.

In one embodiment of the present invention, the screen includes a plurality of openings arranged in a grid pattern. Alternatively, the openings can be arranged in an offset pattern, a random pattern, or a pattern that correlates to a custom design.

In one embodiment of the present invention, the openings can have a generally rectangular cross-section. Alternatively, the openings can have a circular cross-section, a cross-section of any polygonal shape, or a combination of different shaped cross-sections.

In one aspect of use, the present invention provides window screens that can be configured to block direct sunlight from entering an associated window at incidence angles up to about 85 degrees measured from the web plane of the window screen while providing openings in the screen small enough to prevent insects from entering an associated structure. Additionally, the openings provide substantial airflow through the screen and allow for an uninhibited field of view through the screen generally perpendicular to the web.

### BRIEF DESCRIPTION OF THE DRAWINGS

FIG. 1 is a perspective view of a window screen according to the present invention.

FIG. 2 is an exploded view of the area A of the window screen of FIG. 1.

FIG. 3 is a partial cross-sectional view of the window screen of FIG. 1 taken at the line 3-3.

FIG. 4 is a schematic side elevational view of a window screen in accordance with the present invention shown mounted adjacent to the external side of a window of a structure to block sunlight from passing directly through the screen, and consequently the adjacent window, from varying angles to the plane of the screen.

FIG. 5 is a partial side view of a window screen in accordance with the present invention shown as used adjacent a window to block sunlight from passing through the window at varying angles to the screen.

FIG. 6 illustrates an alternative design of a window screen in accordance with the present invention.

FIG. 7 illustrates another alternative design of a window screen in accordance with the present invention.

### DETAILED DESCRIPTION OF THE INVENTION

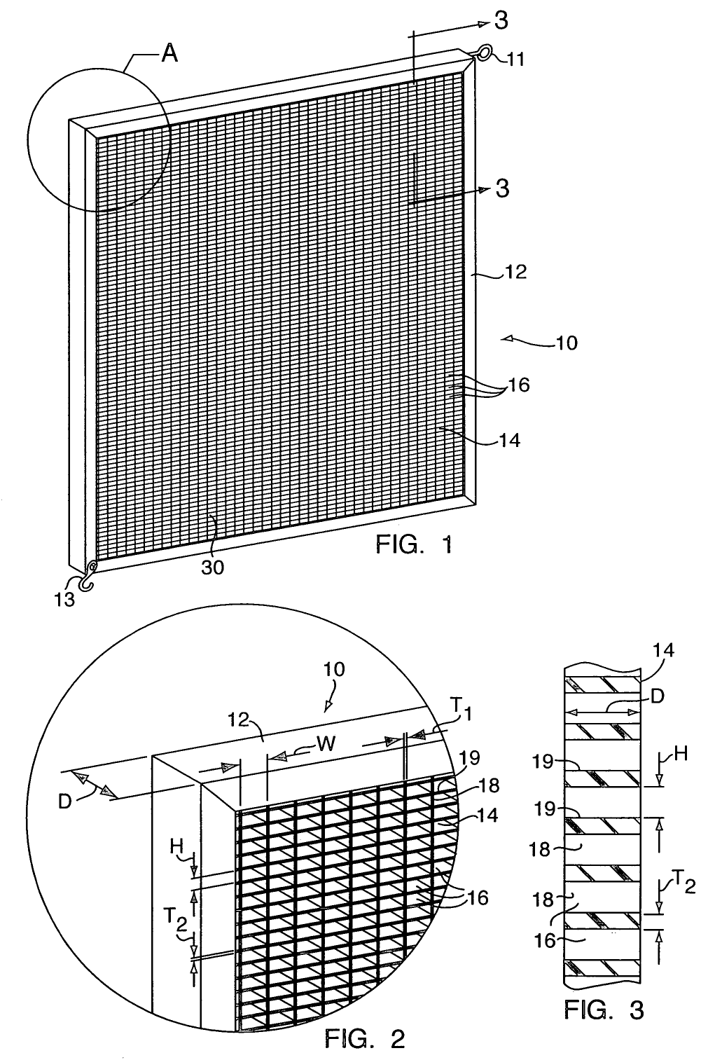

As shown in FIGS. 1-3, the present invention is directed to a window screen generally designated by reference number 10. The window screen 10 includes a frame 12 surrounding and supporting a web 14 having a depth D. The web 14 defines a plurality of openings 16 that allow air and light to pass through the web 14 as will be discussed further below. In the embodiment of the window screen 10 illustrated in FIGS. 1-3, the openings 16 are uniform in size and shape, each with a generally rectangular cross-section having a width Wand a height H, and arranged in a grid pattern. The openings 16 also share the depth D of the web 14 into or by which they are formed or otherwise defined.

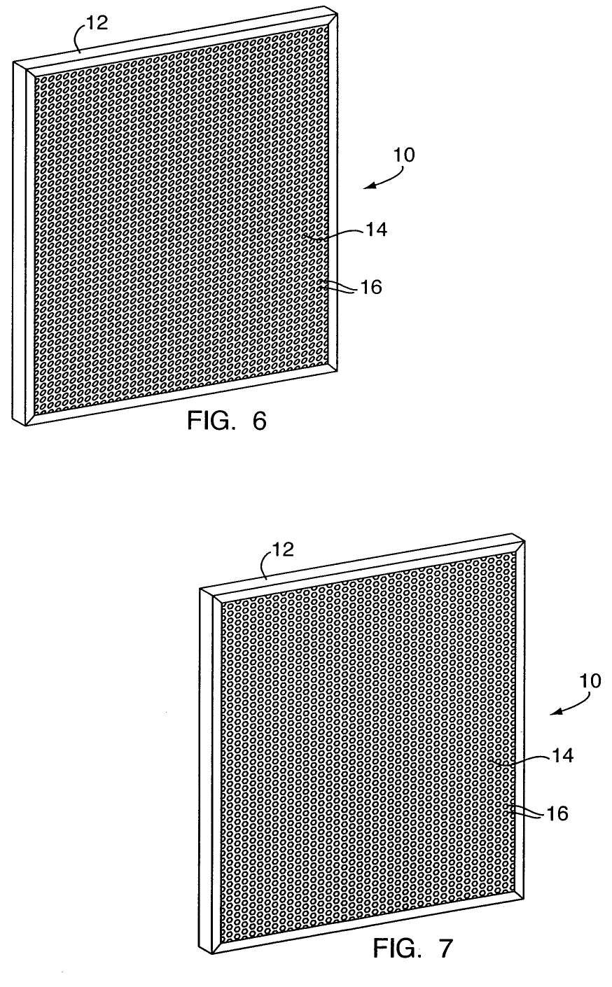

The openings of the present invention need not be uniformly sized or shaped, need not have a rectangular cross-section, or need not be arranged in a uniform grid pattern. In alternate embodiments of the window screen of the present invention, the plurality of openings 16 may have a circular cross-section (as illustrated in FIG. 6), a cross-section of any polygonal shape (as illustrated with hexagons in FIG. 7), or a combination of different shapes. The size of the openings can vary across the web—e.g., the openings in the central area of the web, where more sunlight can enter through the screen, can be smaller in cross-section than the openings around the perimeter of the screen. Further, the openings 16 may be arranged in an offset, quasi-grid-like pattern, as illustrated in FIG. 7, a random pattern, or a pattern based on a customized design (such as a logo or name).

The web 14 shown in FIGS. 1-3 illustrates a preferred shape and arrangement of the openings 16 which are defined by a plurality of warp elements 18 and a plurality of weft elements 19 that are generally perpendicular to each other and formed, or fastened together, so that the openings 16 exhibit generally rectangular cross-sectional shape and are arranged in a grid pattern. The warp elements 18 and weft elements 19 have thicknesses T₁ and T₂, respectively, that are each of appropriate dimension to provide sufficient structural support to the window screen 10 depending on the particular application thereof. For example, a window screen 10 made for use on a vehicle may have thicker warp elements 18 and weft elements 19 for increasing the structural strength of the web 14 than a window screen designed for use on a house. Preferably, the respective thicknesses T₁ and T₂ are equal, but may differ based on the relative dimensions of the width Wand height H of the openings 16 and the desired level of light blocking for the openings 16.

The thickness T₁ of the warp elements 18 and the thickness T₂ of the weft elements 19 contribute to a determination of the amount of the total cross-sectional area of the openings 16 defined by the web 14 relative to a total area of a surface 30 of the web, which is referred to herein as the “Percent Open Area” of the web. The larger the Percent Open Area of the web 14, the more airflow through the window screen 10. Further, the larger the Percent Open Area of the web 14, the more visibility there is through the window screen 10. For example, if the thickness T₁ of the warp elements 18 is equal to approximately 1/10 of the width W of the openings 16, and the thickness T₂ of the weft elements 19 is approximately 1/10 of the height H of the openings 16, then the Percent Open Area of the web 14 and window screen 10 would be equal to about 90%. That is, the area of the warp elements 18 and weft elements 19 occupy about 10 percent of the total surface area of the surface 30 of the web 14 and about 90 percent of the total surface area remains as open area in the openings 16, keeping the visibility through the screen 10 at an acceptable level without eliminating the benefits of the screen for blocking direct sunlight, as discussed in more detail below.

The Percent Open Area of the web 14 may be determined to best suit a particular application and the corresponding warp elements 18, weft elements 19 and openings 16 designed accordingly. For example, where airflow is important, but environmental nuisances (such as insects) minimal or do not affect the occupants or equipment in a structure, the cross-sectional area of the openings 16 can be made relatively large. Alternatively, to prevent environmental nuisances, the openings 16 may be made small, for example, wherein, the cross-sectional area of the openings 16 are in a range between about 1 mm² to about 10 mm². An opening 16 having a maximum height H of 0.5 mm and a maximum width W of 2.0 mm would have a cross-sectional area of about 1 mm². By comparison, an opening 16 having a maximum height H of 2 mm and a maximum width W of 5 mm will have a cross-sectional area of about 10 mm². The area of the openings can have an essentially uniform size, within manufacturing tolerances, or can have a distribution of sizes, provides the varying sizes meet the shadings, view, airflow, and nuisance prevention requirements for the intended use of the window screen.

The warp elements 18 and weft elements 19 which form the web 14 and cooperate to define the openings 16 are made of an appropriate material and thickness to provide a window screen 10 of sufficient structural support depending on the particular application thereof. Preferably, the web 14 can be made from a variety of materials, including but not limited to fiberglass, plastics, ceramics, wood, metals, composite materials, or a combination thereof to provide a stable, yet flexible, weather resistant window screen. Preferably, a polypropylene or nylon material may be used for the web 14. The web material can be selected for UV stability for exterior use in direct sunlight, thereby allowing the material to function for several years or more. Additionally, the material selected for the web 14 should not stretch too much so that the screen 10 can remain taut. Further, the material can be selected for its chemical resistance, if desired, such as ethylene chloretrifluoro ethylene (ECTFE).

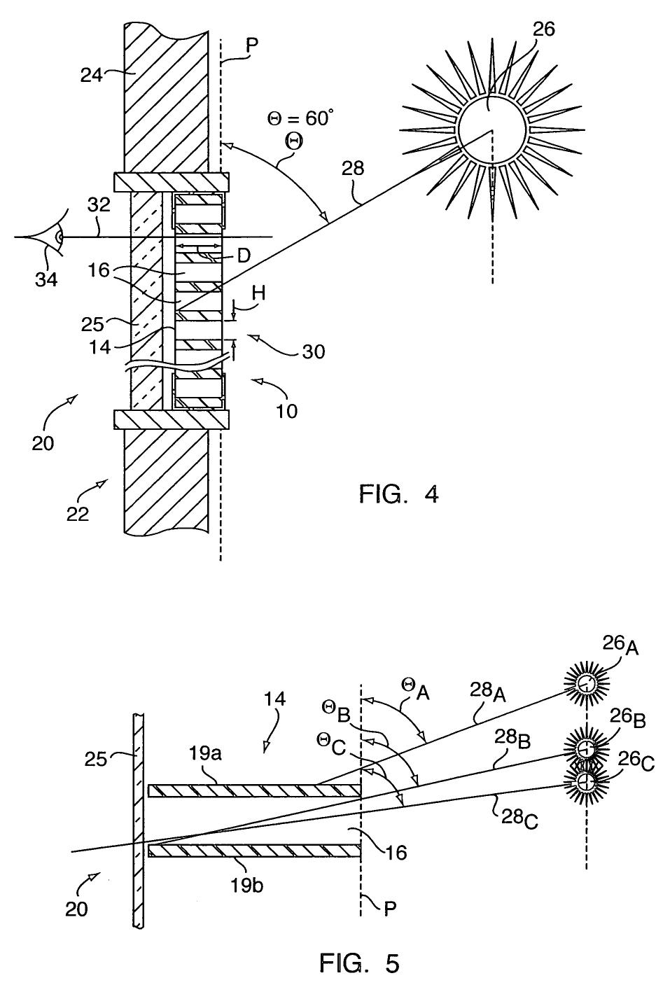

Referring to FIG. 4, the window screen 10 of the present invention is illustrated in a preferred operational setting—i.e., with respect to a window 20 through which sunlight may enter. A structure 22 has a wall 24 that includes the window 20. The window screen 10 is mounted on the exterior side of window 20 adjacent a glass portion 25 of the window 20. A light source, generally depicted as sun 26, projects light rays, illustrated by reference numeral 28, towards the window 20. Light ray 28 is directed toward and strikes the web 14 at angle Θ, illustrated in FIG. 4 at about 60° measured from a plane P defined by an exterior surface 30 of the web 14. Still referring to FIG. 4, light ray 28 is shown incident a surface of the weft element 19 of the web 14, where it is substantially absorbed, reflected, or otherwise blocked, such that most of the energy from light ray 28 does not enter the structure 22 through the window 20.

The window screen 10 of the present invention is adept for blocking direct rays of light from the sun 26 at varying angles to the plane P of the screen 10. FIG. 5 illustrates the sun 26 in three positions A, B and C, representing movement of the sun 26 through the sky. Each position of the sun, illustrated as 26_{A}, 26_{B} and 26_{C}, has corresponding light rays 28_{A}, 28_{B} and 28_{C}, that contact the weft elements 19 of the window shade 10 at the angles Θ_{A}, Θ_{B} and Θ_{C}, respectively. As shown, angle Θ_{A} is smaller than angle Θ_{B}, and thus represents a time of the day where the sun 26_{A} is higher in the sky than the sun 26_{B}.

Still referring to FIG. 5, light ray 28_{A}, shown incident the web 14 at angle Θ_{A}, contacts a weft element 19a of the screen 10 at a middle portion thereof, where it is substantially absorbed, reflected, or otherwise blocked by the weft element 19a and therefore does not pass through the window 20 directly or unimpeded. Light ray 28_{B}, incident the web 14 at angle Θ_{B}, is not blocked by the weft element 19a that blocked light ray 28_{A}. However, light ray 28_{B} contacts the weft element 19b immediately below the first weft element 19a near an inner edge thereof where it is also substantially absorbed, reflected, or otherwise blocked by the weft element 19b—a benefit provided by the depth D of the openings 16. Thereafter, as the sun 26 moves lower in the sky to a point represented by the sun 26_{C}, light ray 28_{C} misses the web 14 and passes directly through the opening 16 and the window 20 entering the structure 22 generally unimpeded.

Typically, the radiant energy of light rays from the sun when it is in a position lower in the sky (essentially the sunrise or sunset hours) is less of a concern than the radiant energy of the sun when it is higher in the sky (e.g., at noon). Thus, when the sun is lower in the sky, temperatures are lower and some direct light rays into the structure do not pose as great a problem as during the times of the day where temperatures are higher. Indeed, at sunrise or sunset, permitting some direct light into the structure may be beneficial to keeping interior space of the structure at an acceptable temperature level to compensate for temperature change outside. Thus, the window screen 10 of the present invention is designed to block direct light from passing unimpeded through the window 20 during times of day where the radiant energy of the sun is high. Accordingly, as illustrated in FIG. 5, the web 14 of the present invention can be configured to block sunlight entering the openings 16 of the web 14 from directly passing through the window at incidence angles Θ in a range from about 0 degrees to about 85 degrees measured from a plane P defined by the exterior surface 30 of the web 14. At other angles, the screen 10 can permit sunlight to enter the window 20 generally unimpeded. The dimensions of the openings 16 can be altered to correlate to different angle ranges of the sun. That is, the screen 10 can be designed to block light rays at incidence angles Θ in a range from about 0 degrees to about 60 degrees, while permitting light to pass through the window generally unimpeded between about 60 degrees and up. This type of screen may be more desirable in a colder climate or during the winter. Preferably, the maximum angle for various designs of the screen 10 is in the range from about 45 degrees to about 85 degrees.

The functionality of the window screen 10 with respect to the blocking of sunlight is related to the ratio of the depth D to the height H of the openings 16 defined by the web 14. Generally, the smaller the height H, the larger the incidence angle Θ of light rays 28 to plane P may be before direct sunlight enters the structure 22. However, merely decreasing the size of the height H, does not necessarily make the window screen 10 acceptable for all uses. Specifically, smaller opening size, while adequately blocking direct light from passing through a window, can severely compromise visibility through the screen. By comparison, the greater the depth D with respect to the height H, the larger the angle of light rays 28 with respect to plane P may be before direct sunlight enters an associated structure generally unimpeded without compromising visibility through the screen 10. The ratio of the depth to the height, D/H (referred to herein as the “awning ratio”) corresponds to the maximum angle Θ of the sun or other energy source makes with the plane P before direct sunlight enters the structure through the web 14. More specifically, tan⁻¹ (D/H) is approximately equal to a maximum angle Θ of the sun 26 relative to the plane P of the web 14 before direct sunlight enters the structure.

In some embodiments of the present invention, the awning ratio D/H provides protection from an energy source like the sun where the angle Θ of the energy source with the web 14 can be from about 0 degrees to almost 90 degrees. In various embodiments, the awning ratio D/H can be selected to provide protection from an energy source where the incidence angle Θ of light source on the web is from about 0 degrees to a maximum angle anywhere within the range between about 45 degrees and about 85 degrees.

For example, in a preferred embodiment of the present invention generally shown in FIG. 4, the window screen 10 has an the awning ratio D/H approximately equal to 1.73 which corresponds to a web 14 configured to prevent direct light rays 28 incident on the web 14 at an angle Θ up to about 60 degrees from the vertical from directly passing through the openings 16 and window 20. Alternatively, in various other embodiments of the window screen 10, the awning ratio can be from about 1 to about 10, which correlate to maximum incidence angles in the range of about 45 degrees to about 85 degrees.

The width W of the openings 16 can be determined based on the desired strength and stability required for the web 14. Typically, the width Wand height H dimensions are selected so that the opening 16 is small enough to prevent insects, bugs or other environmental nuisances from entering a structure to which the window screen 10 is attached. However, if the window screen 10 is designed for use in an environment where insects entering the structure are not a concern, the width Wand height H can be increased to make larger openings 16, so as to increase airflow through the screen. Of course, the depth D needs to be correspondingly increased with relation to the height H so as to maintain a desired awning ratio. For example, a screen 10 capable of preventing insects from passing the screen may have a height H of about 2.0 mm or less. For a height of about 2.0 mm, with a desired awning ratio corresponding to an incidence angle of about 60 degrees, the depth D for the screen should be about 3.46 mm. By comparison, a screen 10 having openings 16 with a height H of about 5.0 mm, for use with a desired awning ratio corresponding to an incidence angle of about 60 degrees, would need a web and opening depth D of about 8.66 mm.

Where it is desirable to view the exterior environment outside a structure, the openings on the screen 10 can be sized to provide a field of view through the screen 10. Referring again to FIG. 4, a person inside the structure 25 can look straight through the window 20 and window screen 10, as represented by the indirect ray 32 shown passing through the web 14 and entering the eye 34. Thus, a field of view through the openings 16 defined by the web 14 and generally perpendicular to the plane P is unobstructed by the web. The Percent Open Area of the window screen 10 of the present invention can be designed, based on the width W, height H, and depth D dimensions of the openings 16 to provide a field of view that is preferably greater than about 50%, more preferably greater than about 70%, even more preferably greater than about 80%, and in some embodiments, ideally greater than about 90%. Such opening dimensions account for a greater field of view through the screen and also accommodate desired levels of ventilation through the screen, all without compromising the awning and shading effects of the screen, based on the selected awning ratio D/H, for direct rays of sunlight at various angles in the sky.

Referring to FIGS. 1-3, the web 14 is constructed of a plurality of warp elements 18 and a plurality of weft elements 19 which are coupled together generally perpendicular to each other to form a grid. Depending on how the web 14 is manufactured, the warp elements 18 and weft elements 19 may be separate from one another and fastened or woven together at the corners of the openings 16. Alternatively, the web 14 may be an extrusion wherein the warp elements 18 and weft elements 19 are formed together in a unitary web, or the openings 16 may be milled or molded to desired dimension.

In one method of manufacturing a screen in accordance with the present invention, the web 14 is formed from an apertured film or an extruded plastic mesh formed from molten plastic in a continuous film defining the openings 16 therein. The shape and size of the openings 16 in an extruded web 14 can be controlled by the geometry of a die used in the extrusion process. The overall width of an extruded web 14 can be determined, in part, based on the width of an extrusion head used. The overall length of an extruded web 14 can typically be unlimited as the web is a continuously formed extrusion.

Alternatively, an accordion-type plastic extrusion may be used to manufacture the web 14. In such a process, the porous structure of the screen could be compressed in one dimension. As the screen is pulled apart in the compressed dimension, the openings 16 are formed.

Another method of manufacturing a screen 10 in accordance with the present invention is to laminate layers of screen together. The base screen layer can be formed from standard processes, such as weave or extrusion, and have a web thickness that is less than the maximum height dimension of the openings. Adding additional layers to the laminate can increase the depth dimension for the screen. Ultimately, in accordance with the present invention, the depth dimension of the laminated screen exceeds the maximum height dimension of the openings to obtain the desired awning ratio for the openings.

In an alternate method of manufacturing a screen 10 in accordance with the present invention, the web 14 may be formed from a plurality of conduit sections, or tubes, coupled or bonded together along the length thereof. In an arrangement formed by this method of manufacture, a plurality of conduit sections of uniform length and opening size form a web 14 having a uniform awning ratio throughout a surface area thereof.

Alternatively, a plurality of conduits of non-uniform length and/or opening size can be arranged to form a web having various awning ratios throughout a surface area defined by the web. The conduit sections could be cylindrical, rectangular, or polygonal in cross-section or a combination of various shaped conduit sections may be used. The conduit sections may be interconnected along their walls or spaces between walls can be used to form a honeycomb, close-packed structure or other irregular structure.

The cross-sectional area of the openings 16 in the web 14 can be of an essentially uniform size (i.e., within manufacturing tolerances) or can have a distribution of sizes provided they meet the shading, view, air flow and nuisance requirements for the intended use of the window screen 10.

FIG. 6 illustrates an alternative design of a window screen 10 in accordance with the present invention. More specifically, openings 16 have a generally circular cross-sectional shape. The circular openings 16 are arranged in an array so as to create a grid pattern. The material of the web 14 between the openings provides structural stability and integrity to the screen 10. Alternatively, the circular openings 16 could be arranged in an offset arrangement, a random arrangement, or an arrangement based on a customized design (such as a logo or name).

FIG. 7 illustrates yet another alternative design of a window screen 10 in accordance with the present invention. In this design, openings 16 have a generally hexagonal cross-sectional shape and are arranged in an offset, quasi-grid pattern.

The window screen 10 can be mounted to an adjacent window or structure using typical fasteners and mounting accessories normally used for mounting window screens, such as insertion of the frame 12 into tracks in the window structure (FIG. 4), or any type of loops 11 or hooks/latches 13, as illustrated in FIG. 1, or holes, screws and tabs (not shown), or any combination thereof. As shown, the window screen 10 includes the illustrated frame 12 to provide stiffness and shape to the screen. During the summer, the screen 10 can provide both shade and insect protection while permitting ventilation and a field of view through the window. In the winter, the screen 10 can be removed and stored if not needed to block the sun or insects. Alternatively, the screen 10 can be provided with a flexible boarder to define the shape of the screen while permitting the screen to be rolled or folded up for storage on a retractable roller, much in the manner of a pull shade. The screen can then be drawn down manually or automatically to provide shade or insect protection when needed.

The window screen 10 can be made in any color. Black or dark colors can be used because they absorb the sunlight and eliminate or minimize light reflection into the home. While the black screen will typically become hot due to absorption of heat from direct light rays, the heat will be outside the structure since the screen 10 is preferably mounted on the exterior side of the structure. Thus, the heat will eventually dissipate from the screen into the surrounding environment, but not within the interior space of the structure.

The foregoing description of embodiments of the invention has been presented for the purpose of illustration and description, it is not intended to be exhaustive or to limit the invention to the form disclosed. Obvious modifications and variations are possible in light of the above disclosure. The embodiments described were chosen to best illustrate the principals of the invention and practical applications thereof to enable one of ordinary skill in the art to utilize the invention in various embodiments and with various modifications as suited to the particular use contemplated. It is intended that the scope of the invention be defined by the claims appended hereto.

What is claimed is:

1. A screen for use on a window of a structure for blocking a portion of direct sunlight from entering the structure through said window while providing a substantially uninhibited field of view through the screen, the screen comprising:
a web having a generally uniform thickness and defining a plurality of openings therethrough,
each said opening having a maximum depth dimension defined by and substantially equal to said thickness of said web and a maximum opening dimension being generally transverse to said maximum depth dimension,
said maximum depth dimension being greater than or equal to said maximum opening dimension such that light rays entering said openings generally in the plane of said maximum opening dimension at an angle measured from a plane defined by a surface of said web are blocked from directly passing through said openings due to said light rays contacting said web along the depth of said openings,
wherein said openings block light rays at an angle from said web plane up to a maximum angle in the range of about 45 degrees to about 85 degrees measured from the web plane, and
wherein a field of view through said openings generally perpendicular to said plane is generally uninhibited by said web.

2. The screen according to claim 1 wherein said plurality of openings are arranged in a grid pattern.

3. The screen according to claim 1 wherein each of said plurality of openings has a generally polygonal cross-section.

4. The screen according to claim 3 wherein each of said plurality of openings has a generally rectangular cross-section, and said maximum opening dimension corresponds to a height dimension of said rectangular cross-section within the web of the screen.

5. The screen according to claim 1 wherein said maximum depth dimension is greater than said maximum opening dimension such that sunlight entering said openings at an angle up to about 60 degrees measured from the web plane are blocked from directly passing through said openings.

6. The screen according to claim 1 further comprising mounting means for externally mounting the screen adjacent a window of a structure.

7. The screen according to claim 1 wherein said web is formed from a plurality of conduit sections bonded together along the lengths thereof, each said conduit section defining one of said plurality of openings.

8. The screen according to claim 7 wherein each said conduit section is cylindrical in shape.

9. The screen according to claim 7 wherein each said conduit section defines an opening having a cross-section in the shape of a polygon.

10. The screen according to claim 1 wherein said web further defines a maximum width dimension for each said opening, said maximum width dimension being generally transverse to both of said maximum depth dimension and said maximum opening dimension, said maximum width dimension being less than an overall width of said screen.

11. The screen according to claim 1 wherein the plurality of openings are dimensioned such that the total area of the cross-section of each of said opening is in a range of about 1.0 mm² to about 10.0 mm².

12. A screen for use on a window of a structure for blocking a portion of direct sunlight from entering the structure through said window while providing a substantially uninhibited field of view through the screen, the screen comprising:
a web having a generally uniform thickness and defining a plurality of openings therethrough,
each said opening having a maximum depth dimension defined by and substantially equal to said thickness of said web and a maximum opening dimension being generally transverse to said maximum depth dimension,
wherein the ratio of said maximum depth dimension to said maximum opening dimension for each said opening is in the range of about 1 to about 10 such that light rays entering said openings generally in the plane of said maximum opening dimension at an angle measured from a plane defined by a surface of said web are blocked from directly passing through said openings due to said light rays contacting said web along the depth of said openings, and
wherein a field of view through said openings generally perpendicular to said plane is generally uninhibited by said web.

13. The screen according to claim 12 wherein the ratio of said maximum depth dimension to said maximum opening dimension for each said opening is in the range of about 1.5 to about 1.8.

14. The screen according to claim 12 wherein the plurality of openings are dimensioned such that the total area of the cross-section of each of said opening is in a range of about 1.0 mm² to about 10.0 mm².

15. A screen for use on a window of a structure for blocking a portion of direct sunlight from entering the structure through said window while providing a substantially uninhibited field of view through the screen, the screen comprising:
a web defined by a plurality of warp elements coupled to a plurality of weft elements, the warp and weft elements cooperating to a define a plurality of openings arranged in a grid pattern,
each said opening having a maximum depth dimension defined by and substantially equal to a thickness of said weft elements and a maximum opening dimension defined between adjacent weft elements,
said maximum depth dimension being greater than or equal to said maximum opening dimension such that light rays entering said openings generally in the plane of said maximum opening dimension at an angle measured from a plane defined by a surface of said web are blocked from directly passing through said openings due to said light rays contacting said web along the depth of said openings,
wherein said openings block light rays at an angle from said web plane up to a maximum angle in the range of about 45 degrees to about 85 degrees measured from the web plane, and
wherein a field of view through said openings generally perpendicular to said plane is generally uninhibited by said web.

16. The screen according to claim 15 wherein said maximum depth dimension is greater than said maximum opening dimension such that sunlight entering said openings at an angle up to about 60 degrees measured from the web plane are blocked from directly passing through said openings.

17. The screen according to claim 15 wherein the plurality of openings are dimensioned such that the total cross-sectional area of each said opening is in a range of about 1.0 mm² to about 10.0 mm².

18. The screen according to claim 15 wherein the ratio of said maximum depth dimension to said maximum opening dimension for each opening is in the range of about 1 to about 10.

19. The screen according to claim 15 wherein the ratio of said maximum depth dimension to said maximum opening dimension for each opening is in the range of about 1.5 to about 1.8.
